(19) United States
(12) Patent Application Publication
(10) Pub. No.: US 2018/0011492 A1
(43) Pub. Date: Jan. 11, 2018

(54) SERVICE PROVIDING DEVICE AND SYSTEM AND NON-TRANSITORY COMPUTER READABLE MEDIUM

(71) Applicant: FUJI XEROX CO., LTD., Tokyo (JP)

(72) Inventors: Hajime KAJIYAMA, Kanagawa (JP); Kunitoshi YAMAMOTO, Kanagawa (JP); Naoya OGATA, Kanagawa (JP); Hideki FUJIMOTO, Kanagawa (JP); Mariko MIYAZAKI, Kanagawa (JP); Toshihiko SHIBUSAWA, Kanagawa (JP); Masatoshi MARUO, Kanagawa (JP); Hirokazu TSUBOTA, Kanagawa (JP); Yasuharu SAKURAI, Kanagawa (JP); Tetsuya KOBAYASHI, Kanagawa (JP)

(73) Assignee: FUJI XEROX CO., LTD., Tokyo (JP)

(21) Appl. No.: 15/446,261

(22) Filed: Mar. 1, 2017

(30) Foreign Application Priority Data
Jul. 5, 2016 (JP) 2016-133155

(51) Int. Cl. G05D 1/02; B60P 3/025

(52) U.S. Cl. CPC G05D 1/021; B60P 3/0257

(57) ABSTRACT

A service providing device includes a mobile unit, a providing unit, and an obtaining unit. The mobile unit moves to a destination. The providing unit moves together with the mobile unit and provides a service. The obtaining unit obtains information at a destination at which the providing unit provides a service.

### CROSS-REFERENCE TO RELATED APPLICATIONS

This application is based on and claims priority under 35 USC 119 from Japanese Patent Application No. 2016-133155 filed Jul. 5, 2016.

### BACKGROUND

### Technical Field

The present invention relates to a service providing device and system and a non-transitory computer readable medium.

### SUMMARY

According to an aspect of the invention, there is provided a service providing device including a mobile unit, a providing unit, and an obtaining unit. The mobile unit moves to a destination. The providing unit moves together with the mobile unit and provides a service. The obtaining unit obtains information at a destination at which the providing unit provides a service.

### BRIEF DESCRIPTION OF THE DRAWINGS

An exemplary embodiment of the present invention will be described in detail based on the following figures, wherein:

FIG. 1 is a schematic diagram illustrating an example of the configuration of a service providing system according to the exemplary embodiment;

FIG. 2 is a plan view illustrating an office to which the exemplary embodiment is applied;

FIG. 3 is a block diagram illustrating an example of the hardware configuration of a service providing device in the exemplary embodiment;

FIG. 4 is a block diagram illustrating an example of the hardware configuration of an internal server in the exemplary embodiment;

FIG. 5 is a flowchart illustrating the overall processing executed by the service providing system in the exemplary embodiment;

FIG. 6 illustrates a screen before a user logs in a service providing application;

FIG. 7 illustrates a screen while a user is logging in the service providing application;

FIG. 8 illustrates a screen after a user has logged in the service providing application;

FIG. 9 illustrates a screen indicating a state in which a user is performing a drag-and-drop operation by using the service providing application;

FIG. 10 is a table illustrating the structure of data sent from a service providing device to the internal server; and

FIG. 11 is a flowchart illustrating processing executed by a service providing device in the exemplary embodiment.

### DETAILED DESCRIPTION

The exemplary embodiment of the invention will be described below in detail with reference to the accompanying drawings.

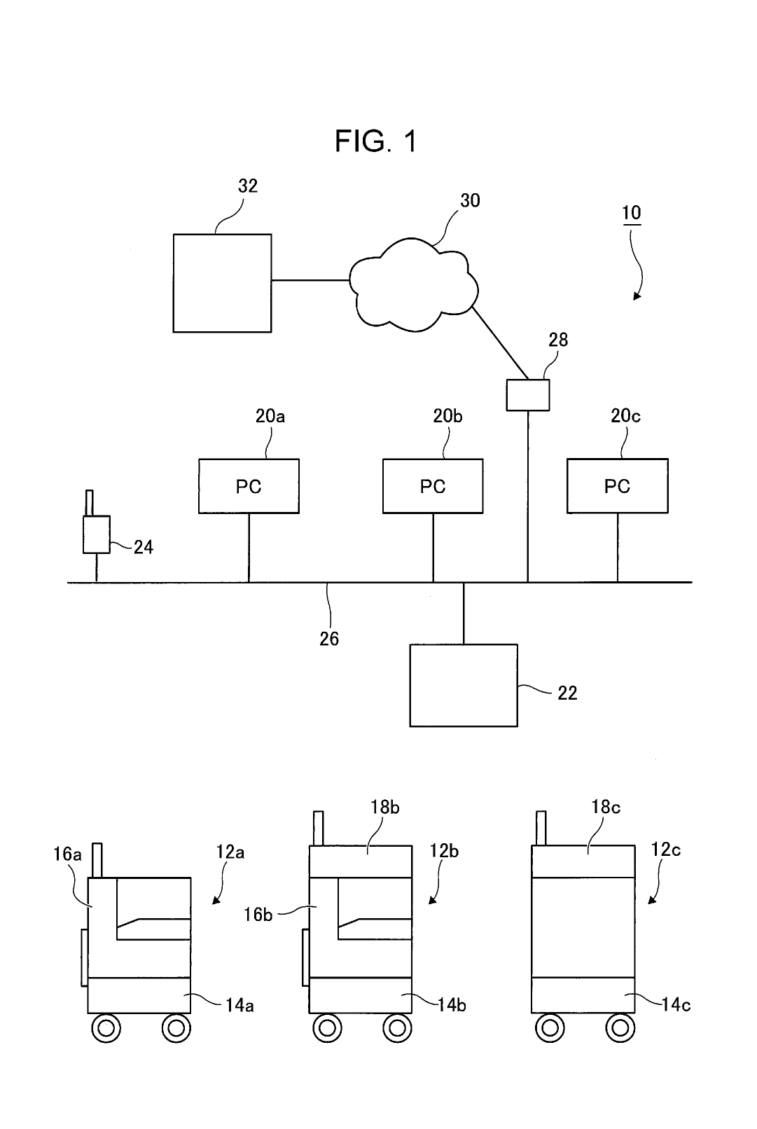

FIG. 1 is a schematic diagram illustrating an example of the configuration of a service providing system 10 according to the exemplary embodiment.

The service providing system 10 includes three service providing devices 12a, 12b, and 12c, for example. The service providing devices 12a, 12b, and 12c respectively include mobile units 14a, 14b, and 14c so that they can move in the office, for example, as desired. The service providing device 12a provides print services and includes an image forming unit 16a installed on the mobile unit 14a. The service providing device 12b provides print services and food and drink services and includes an image forming unit 16b installed on the mobile unit 14b and a service providing unit 18b installed on the image forming unit 16b. The service providing device 12c provides food and drink services and includes a service providing unit 18c installed on the mobile unit 14c. In this specification, the service providing device 12c will primarily be discussed.

In the service providing system 10, many personal computers (PCs) 20a, 20b, and 20c, an internal server 22, and a wireless terminal 24 are connected to one another via a local area network (LAN) 26. The LAN 26 is connected to the Internet 30 via a router 28, and an external server 32 is connected to the Internet 30.

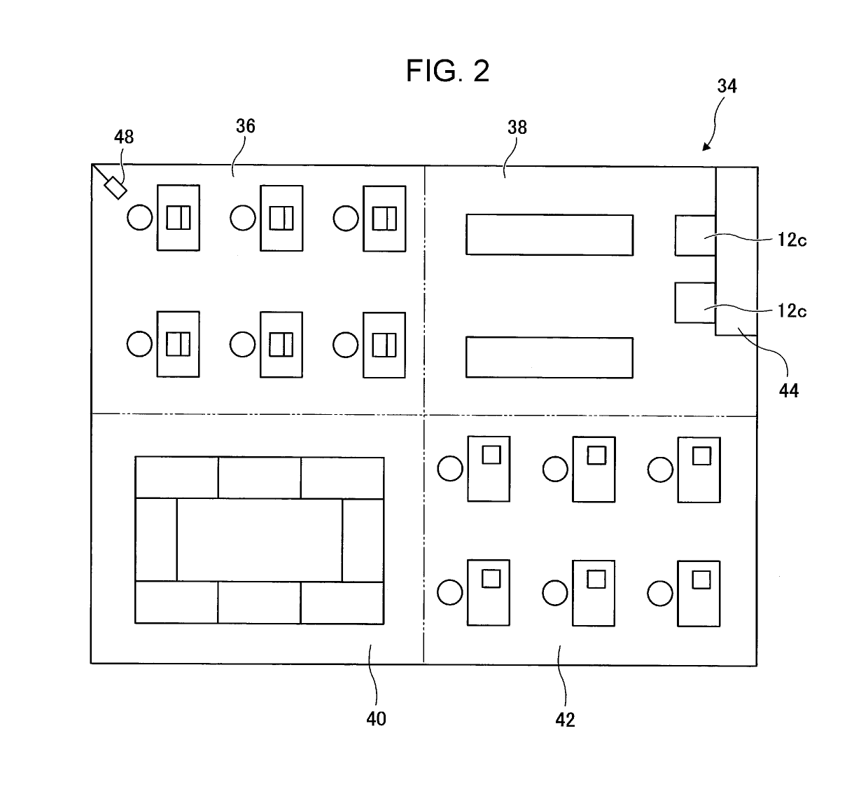

FIG. 2 is a plan view illustrating an office 34 where the service providing devices 12c are disposed.

The office 34 is divided into plural areas, such as a PC work area 36, a laboratory area 38, a meeting area 40, and a telephone-answering area 42. Many PCs are disposed in each of the areas 36 through 42. In the office 34, a storage cabinet 44 for storing goods is installed. The plural service providing devices 12c extract goods from the storage cabinet 44. The position of the storage cabinet 44 may serve as a home position of the service providing devices 12c. A security camera 48 is also installed in the office 34.

The office 34 is not limited to one floor and may have multiple floors. In this case, the service providing devices 12c can move between different floors by using the elevator, for example.

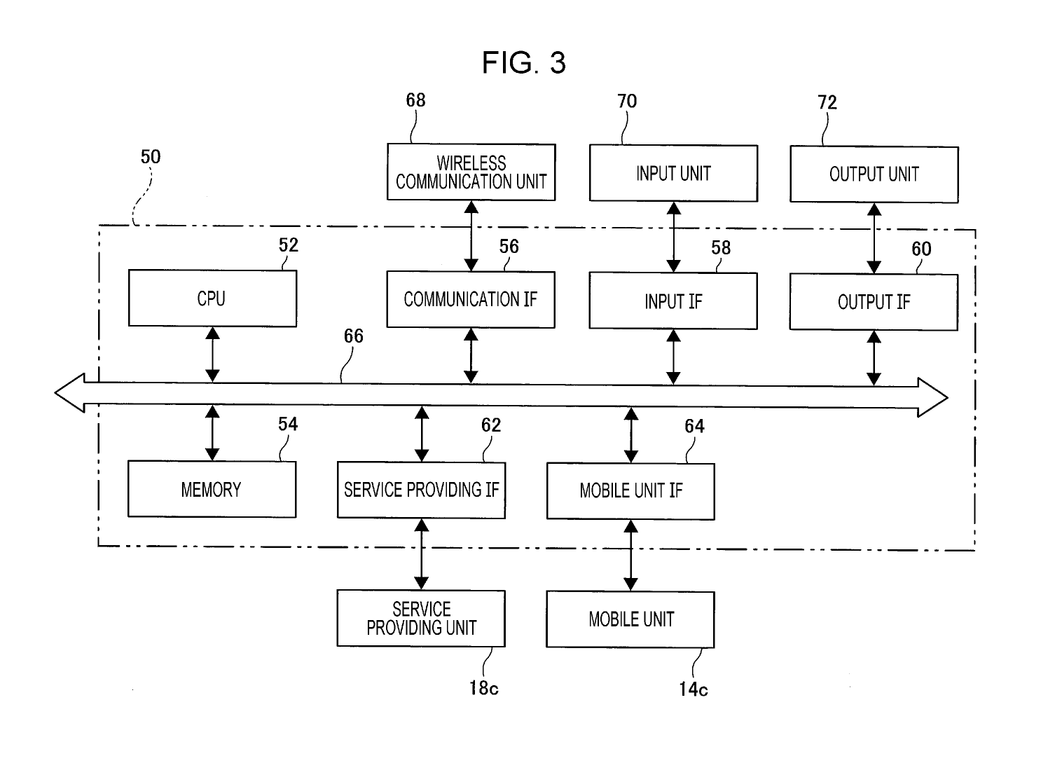

FIG. 3 is a block diagram illustrating a controller 50 of the service providing device 12c.

The controller 50 includes a central processing unit (CPU) 52, a memory 54, a communication interface 56, an input interface 58, an output interface 60, a service providing interface 62, and a mobile unit interface 64, and these elements are connected to one another via a control bus 66.

The CPU 52 executes predetermined processing based on a control program stored in the memory 54. A wireless communication unit 68 is connected to the communication interface 56, and the communication interface 56 performs data communication via the wireless communication unit 68. An input unit 70 is connected to the input interface 58, and the input interface 58 receives input information from the input unit 70.

The input unit 70 includes a camera, a microphone, a weather condition input portion, a room temperature sensor, and a humidity sensor, and obtains information at a destination. For example, the camera takes an image of a user's face and performs identification verification. The camera also takes images of the user's facial expressions before and after the user receives a service so as to determine whether the user satisfies the service. The microphone picks up user's voice or surrounding sound. The weather condition input portion is disposed outside the office 34, and obtains weather conditions (clear, cloudy, rain, etc.) via a communication unit when a service is provided. The room temperature sensor and the humidity sensor respectively obtain data concerning the room temperature and the humidity before and after a service is provided. The input unit 70 may also include a thermographic device that measures the user's temperature. The input unit 70 also includes an ID input portion into which a user's ID is input by using an integrated circuit (IC) card.

An output unit 72 is connected to the output interface 60. The output unit 72 includes a display and a speaker.

The above-described service providing unit 18c is connected to the service providing interface 62. The service providing unit 18c provides drinks such as juice and coffee and food such as sweets. When providing juice, the service providing unit 18c extracts or selects various kinds of juices such as orange juice and apple juice. When providing coffee, the service providing unit 18c extracts or selects various kinds of coffees such as black coffee, latte, and iced coffee.

The above-described mobile unit 14c is connected to the mobile unit interface 64. The CPU 52 receives a moving command from the internal server 22 and then controls the mobile unit 14c in accordance with the moving command.

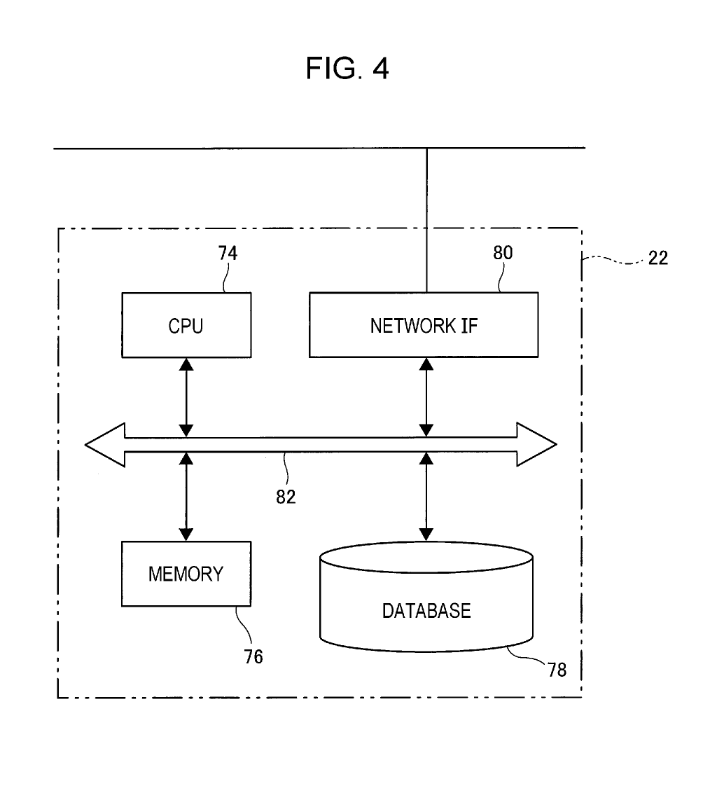

FIG. 4 is a block diagram illustrating a control section of the internal server 22.

The internal server 22 includes a CPU 74, a memory 76, a database 78, and a network interface 80, and these elements are connected to one another via a control bus 82. The CPU 74 executes predetermined processing based on a control program stored in the memory 76 so as to control the internal server 22. The memory 76 stores the control program. The database 78 stores, for example, user authentication information, user position information (the position of a registered user PC and the position of the user based on the user's schedule), office map, and service providing information, as a database.

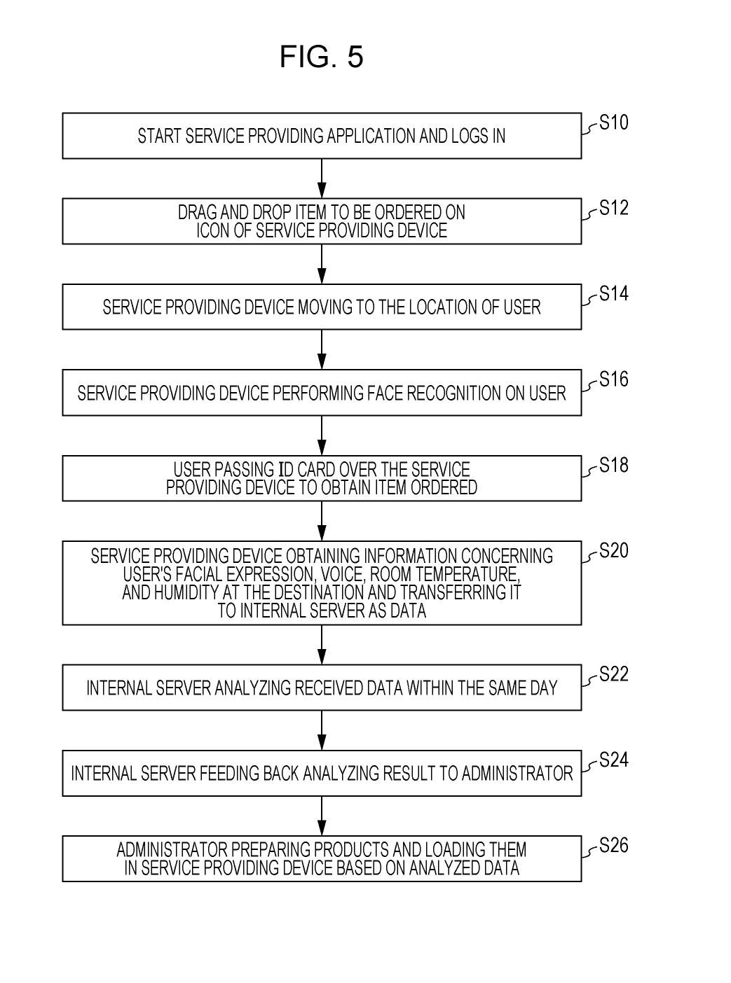

FIG. 5 is a flowchart illustrating the overall processing executed by the service providing system 10.

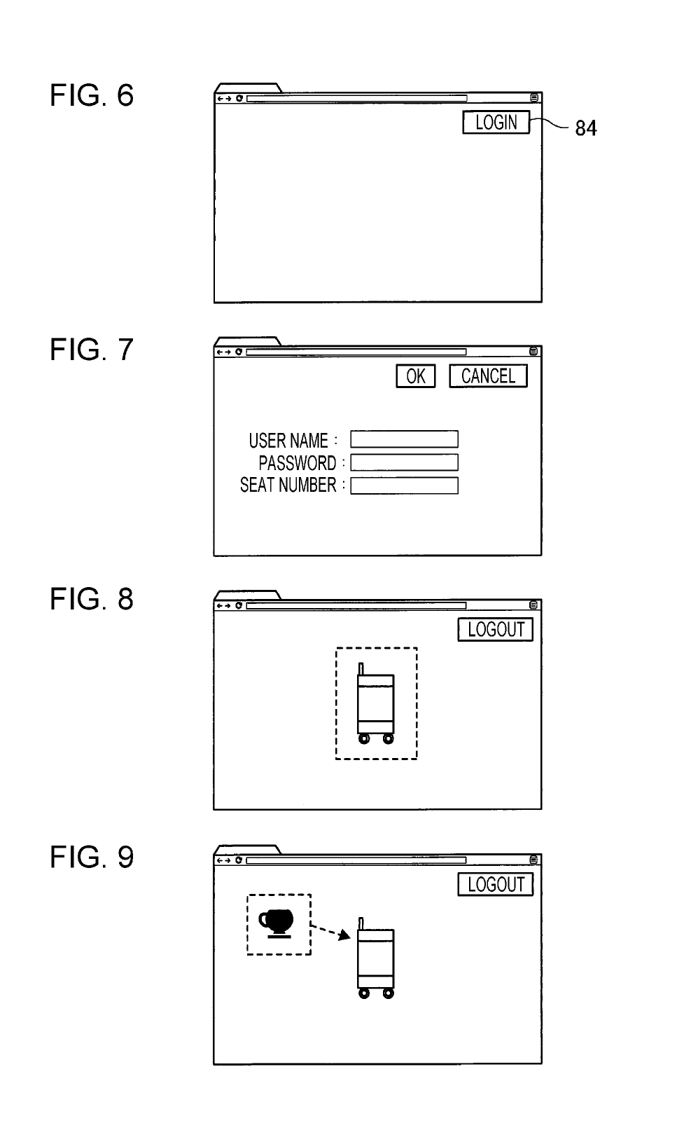

In step S10, a user starts a service providing application and logs in by using corresponding one of the PCs 20a through 20c. As shown in FIG. 6, a login button 84 is displayed on the screen of the PC 20a, 20b, or 20c. When the user presses the login button 84, a screen showing a user name, a password, and a seat number is displayed as shown in FIG. 7. The user then inputs the user name, password, and seat number, and the service application program is ready for use. Then, an option (icon) of the service providing device is displayed, as shown in FIG. 8.

Then, in step S12, the user drags and drops an item that the user wishes to order on the icon of the service providing device, as shown in FIG. 9. Then, information concerning the user and the item selected by the user is output from the PC 20a, 20b, or 20c to the internal server 22, and a moving command is output from the internal server 22 to one of the service providing devices 12c.

Then, in step S14, upon receiving the moving command from the internal server 22, the service providing device 12c starts to move and stores position information indicating the location of the desk of the user logged in by using the service providing application and face recognition information concerning the user. The position information and the face recognition information are transferred from the internal server 22. The service providing device 12c performs face recognition on the user by using the security camera 48. If the service providing device 12c identifies the presence of the user in the office 34, it moves to the location (destination) where the user has ordered the item, for example, coffee, based on the position information.

In step S16, when the service providing device 12c is approaching the destination, it performs face recognition again by using the camera of the service providing device 12c. If the face recognition has succeeded, the service providing device 12c is ready to provide a service, to make coffee, for example.

Then, in step S18, when the user passes the ID card over the service providing device 12c, the service providing device 12c verifies the user ID against the user authentication ID stored in the database 78 of the internal server 22. If the two IDs coincide with each other, the service providing device 12c starts making coffee.

The service providing system 10 may have the following option as one of the server functions. If the service providing device 12c fails to perform face recognition by using its camera for some reason, face recognition may be performed by using a web camera included in corresponding one of the PCs 20a through 20C via the service providing application.

Then, in step S20, the service providing device 12c transfers information concerning the user's facial expression, voice, room temperature, humidity, etc. obtained at the destination to the internal server 22.

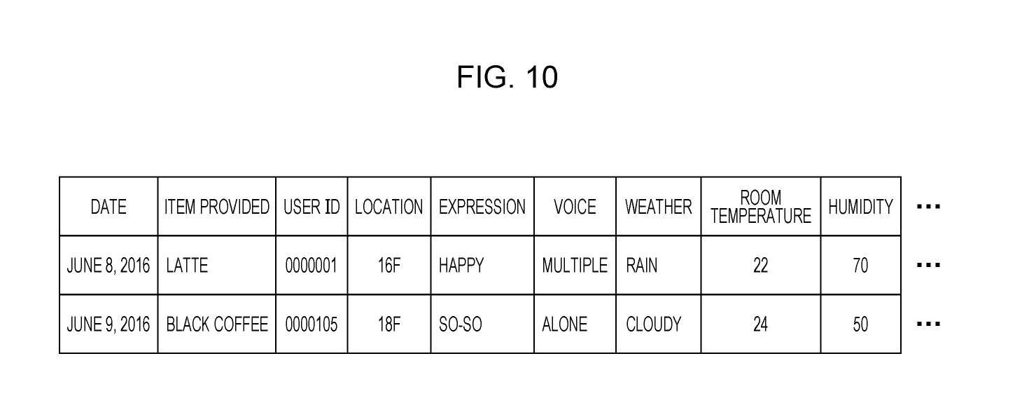

In this manner, the information obtained by the service providing device 12c is associated with the date, user, and location, as shown in FIG. 10. More specifically, the date, item provided, user ID, location, expression, voice, weather, room temperature, humidity, etc. are associated with each other.

In addition to the above-described information, the service providing device 12c may also obtain the following items of information (1) through (3).

(1) User's temperature, estimated height, estimated weight (body type), gender, and age (age group)

(2) Conversation between the user and the service providing device 12c

(3) Conversion between the user and the others

(1) The user's temperature is measured by a thermographic device. The height and the weight may be estimated 1) by the distance between the service providing device 12c and the user, 2) by the size of the user's body extracted from a camera image, and 3) by referring to combinations of the sizes of bodies and the heights or weights stored in the memory 54 as a table. The gender and the age group may also be estimated by a common image recognition technique.

(2) The service providing device 12c may have a speaking function and converse with a user when providing a service. For example, when providing a service, the service providing device 12c explains the content of the service, and then asks what the user thinks about the service and listens to an answer from the user. The service providing device 12c records the whole conversation with the user. For example, the service providing device 12c says “this is mocha coffee with less sugar”, and then waits for a while. When the user sips the coffee, the service providing device 12c asks the user for opinion. “How would you like the taste?” Then, the conversation between the service providing device 12c and the user may continue as follows. “Very good!” “Which one would you like this one or the rich-taste mocha coffee you ordered last time?” “Well, maybe I like this one, this is more refreshing.” “It's been hot lately, and more and more people are ordering this one.” “We're looking forward to your order again, thank you very much!” Thereafter, the service providing device 12c starts returning to the home position or moving around in the office 34. Before or during a conversation with the user, if the service providing device 12c receives an order from another user, it may just thank the user without asking for opinion and start to move to the new user. The service providing device 12c conducts conversation with the user by using artificial intelligence (AI) based on the past histories of users.

(3) As in (2), when providing a service to multiple users or when providing a service to one of the multiple users, the service providing device 12c records their conversation.

The above-described items of information (1) through (3) can be personal information concerning the physical features or conversation including confidential information. Thus, these items of information are processed before or after recording them. For example, the physical features are roughly categorized as “slender”, “standard”, and “well-built”, and the age is roughly categorized as “twenties”, “thirties”, and so on. The content of conversation is also conceptualized and is then recorded. For example, the content of conversation is roughly categorized as “positive” or “negative”. Alternatively, the content of conversation is categorized in terms of the user's emotional expressions such as “happy”, “satisfied”, “disappointed”, and “surprised”.

Then, in step S22, the internal server 22 analyzes the received information within the same day.

More specifically, the internal server 22 decides the numbers and types of items to be prepared for the next day, based on the information shown in FIG. 10. For example, if it is found that, on a certain day, a new latte sold the best on all the floors where the service providing devices 12c are installed, the internal server 22 estimates that this latte will sell well for a while and increases the number of cartridges of latte to be loaded in the service providing device 12c by 1.5 times for the next day. The internal server 22 also determines from the expression information and the voice information whether the user was drinking latte alone or with some people. If the user was drinking latte with some people, the internal server 22 increases the number of service providing devices 12c or instructs a service providing device 12c providing sweets to accompany the service providing device 12c providing drinks.

As feedback to the service providing device 12c, the internal server 22 sends various suggestions to the controller 50 of the service providing device 12c. For example, the internal server 22 suggests to the controller 50 that the service providing device 12c go around or move to a location in a certain time period in which drinks sell well in the office 34. The internal server 22 also estimates what kind of service in which location at what time will be demanded, based on the situations in the past (for example, the room temperature and the humidity in addition to the time and the location). The internal server 22 then instructs the service providing device 12c to move to the estimated location at the estimated time. It is assumed, for example, that more orders were received in the past in a certain range of an area than the other areas on the same floor in a time period of 15:00 to 16:00 at a room temperature of 26° or higher and a humidity of 50% or higher. If the current conditions are or will be likely to be similar to those described above, the internal server 22 suggests to the controller 50 that the service providing device 12c go to this area in this time period. If a predetermined condition is satisfied (for example, an order has not been received), the controller 50 instructs the service providing device 12c to go to this area, based on the received suggestion.

Even in an area where no services were provided before, if conditions in this area are similar to the conditions in an area where many services were provided before, the internal server 22 may suggest to the controller 50 that the service providing device 12c go to this area in a similar time period, for example. Attributes of areas where services will be provided (for example, the sizes of certain areas and the number of people in the areas such as the above-described PC work area 36, laboratory area 38, meeting area 40, and telephone-answering area 42) are registered in advance, together with environment information concerning the environments where services are provided. Then, even in an area where no services were provided before, if the environment information concerning the room temperature and the time period and the area attributes of this area are similar to those of an area where many orders were received before, the internal server 22 may suggest to the controller 50 that the service providing device 12c go to this area in this time period.

In the above-described example, the internal server 22 suggests a location where the service providing device 12c provides services, based on the time period and the area. In addition to or instead of the area, an individual user may be specified. For example, if a user A often requests an order in a certain time period or there are no other users but the user A requesting an order in a certain time period, the internal server 22 suggests to the controller 50 that the service providing device 12c move to the location of the user A in this time period. The controller 50 specifies the location of the user present in this time period and instructs the service providing device 12c to move to this location. The location of the user A may have been associated with the seat of the user A on the office map which the service providing device 12c checks while moving, and the service providing device 12c may specify the location of the user A by referring to this office map. Alternatively, the controller 50 may check the schedule of the user A, and if the user A is at its desk in this time period, the controller 50 instructs the service providing device 12c to move to the location of the user A as described above. If the user A is in the meeting in this time period, the controller 50 may specify the location of the meeting room and instruct the service providing device 12c to move to the meeting room by referring to the office map. Alternatively, the controller 50 may stop the service providing device 12c from moving to the meeting room so as not to disturb the user A.

In step S24, the internal server 22 feeds back the analyzing results obtained in step S22 to the administrator. The administrator is a person who is responsible for the upkeep and operation of the service providing system 10 or the administrator's PC 20a, 20b, or 20c.

Analyzing results are fed back by email. In this case, information for ordering products provided by the service providing device 12c is appended to the email. This information indicates the product names, recommendation reasons, and a uniform resource locator (URL) of a site where a user can place an order.

In step S26, the administrator prepares products based on the analyzed data and loads them in the service providing device 12c. Preparing and loading of products in the service providing device 12c may be conducted by the administrator. Alternatively, the administrator may instruct a robot which is responsible for the storage cabinet 44 to prepare and load products. If products are out of stock in the storage cabinet 44, the robot may instruct the administrator to add products.

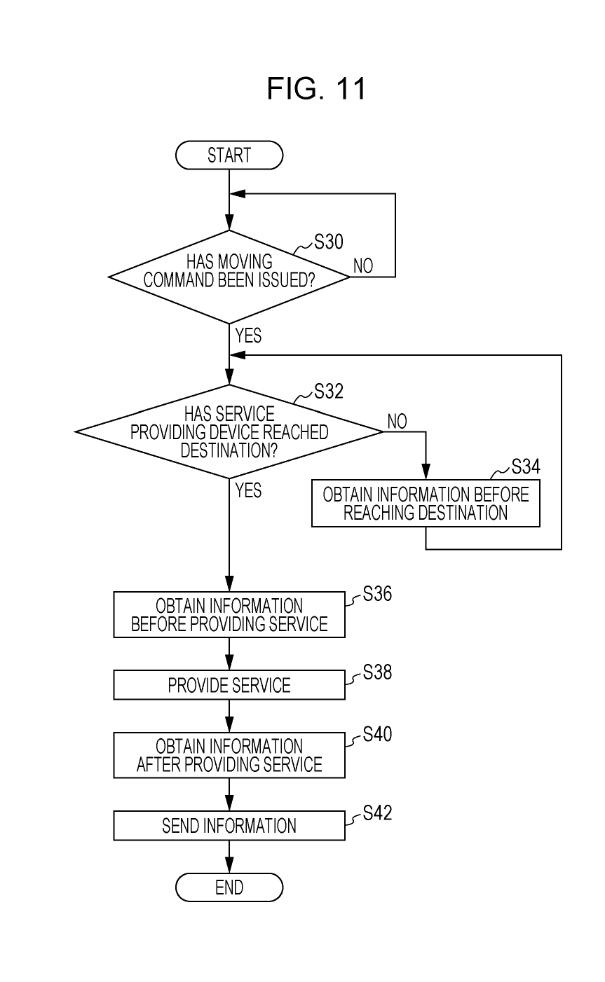

FIG. 11 is a flowchart illustrating the processing executed by the service providing device 12c.

In step S30, the service providing device 12c determines whether a moving command has been issued by corresponding one of the PCs 20a through 20c or the internal server 22. If a moving command has not been issued, the service providing device 12c waits at the home position, for example, at the storage cabinet 44, until a moving command is issued.

If it is determined in step S30 that a moving command has been issued, the service providing device 12c determines in step S32 whether it has reached a destination. If it is determined that the service providing device 12c has not reached a destination, the process proceeds to step S34. In step S34, the service providing device 12c obtains information before reaching the destination. For example, if the service providing device 12c identifies a user to receive a service at a point separated from the destination by a predetermined distance, it obtains the user's expression, gesture, and voice. In this case, the service providing device 12c may specify the user positioned closest to the destination as the user to receive a service. Alternatively, face information concerning the user requested an order may be registered in advance, and the service providing device 12c may conduct face recognition based on the face information by using the camera of the service providing device 12c so as to specify the user to receive a service.

If it is determined in step S32 that the service providing device 12c has reached the destination, the process proceeds to step S36. In step S36, the service providing device 12c obtains information before providing a service.

Then, in step S38, the service providing device 12c provides a service, for example, making coffee.

Then, in step S40, the service providing device 12c obtains information after it has provided a service. In step S42, the service providing device 12c sends the items of information obtained in steps S34, S36, and S40 to the internal server 22.

In steps S36 and S40, in addition to the room temperatures before and after a service is provided, the service providing device 12c obtains the user's expressions, voice (volume and tone), and user's temperatures before and after providing a service. The end of the provision of a service may be a time when the user receives coffee, or when the user takes a sip of coffee, or when the user has finished the coffee. The time before a service is provided may be a period from when the service providing device 12c has reached the destination until it provides a service, or may include a time before the service providing device 12c has reached the destination.

The internal server 22 may determine from these items of information whether the user has had a favorable impression about the provision of a service and may record the result. This result may include the conclusion that the user has had a favorable impression and also reasons supporting this conclusion. For example, the result may include “favorable” and “how much the user has had a favorable impression” with “part of the content of conversation”, “expression”, and “gesture”, which serve as reasons supporting the favorable impression. These features are only examples, and other features may also be included, or a combination of some of the features may be stored. In this manner, for each of the services to be provided, the expression when the user receives a service and a change that the user has made after receiving a service are detected and are recorded together with environment information concerning the room temperature, for example, in association with the service. Then, by using the recorded information, the internal server 22 decides which products are popular among the users. For example, the internal server 22 extracts products that the users have had a more favorable impression than the other products, and feeds back such products. The internal server 22 also determines what kinds of products have been chosen under what kinds of environments (area attribute, time period, and room temperature), and feeds back this information (environments and products) to the administrator who is responsible for an area having similar environments.

The external server 32 is disposed in a manufacturer which develops products related to the services. The internal server 22 sends analyzed information to the external server 32. The internal server 22 conducts statistical calculations from plural items of recorded information so as to specify for what kinds of services under what kinds of conditions many orders are received. The internal server 22 then sends this information to the manufacturer.

The internal server 22 may conduct demand forecasting from the recorded information. For example, the internal server 22 may forecast that orders for refreshing orange juice will increase three months later from now, for example, in July, in the PC work area 36 having about 45 employees among which the ratio of women is 60% or higher. The internal server 22 sends this forecast to the external server 32 in the manufacturer.

This forecast may directly be sent to the controller 50 of the service providing device 12c. Such a forecasting unit may be integrated in the service providing device 12c. In this case, in order to provide more services at the estimated period in the forecast, the controller 50 instructs the administrator or the robot which is responsible for the storage cabinet 44 to load more products, for example, more refreshing orange juices, related to this service in the service providing device 12c. If the service providing device 12c is a device loading a coffee machine, the controller 50 instructs the administrator or the robot to load more cartridges of recommended type of coffee in the service providing device 12c.

In the above-described exemplary embodiment, the food and drink service has been discussed. However, the present invention is not restricted to this type of service. The invention is applicable to other types of services such as printing, the provision of stationery and medicine in the office, the provision of parts and tools in the factory, and cleaning services.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A service providing device comprising:
a mobile unit that moves to a destination;
a providing unit that moves together with the mobile unit and provides a service; and
an obtaining unit that obtains information at a destination at which the providing unit provides a service.

2. The service providing device according to claim 1, wherein the obtaining unit obtains information before a service is provided and information after the service is provided.

3. The service providing device according to claim 1, wherein the obtaining unit obtains information concerning a change which has been made by the provision of a service.

4. The service providing device according to claim 1, wherein the obtaining unit obtains information concerning an emotional expression of a person receiving a service.

5. The service providing device according to claim 1, further comprising:
a sender that sends the information obtained by the obtaining unit.

6. A service providing system comprising:
a mobile unit that moves to a destination;
a providing unit that moves together with the mobile unit and provides a service;
an obtaining unit that obtains information at a destination at which the providing unit provides a service; and
an evaluating unit that evaluates a service provided by the providing unit, based on the information obtained by the obtaining unit.

7. The service providing system according to claim 6, wherein the evaluating unit determines whether a person received a service has a favorable impression about the service.

8. The service providing system according to claim 6, further comprising:
a managing unit that manages a service to be provided by the providing unit, based on an evaluation result obtained from the evaluating unit.

9. A non-transitory computer readable medium storing a program causing a computer to execute a process, the process comprising:
moving to a destination;
providing a service; and
obtaining information at a destination at which a service is provided.
